(19) United States
(12) Patent Application Publication
(10) Pub. No.: US 2025/0190752 A1
(43) Pub. Date: Jun. 12, 2025

(54) METHODS AND SYSTEMS FOR PROCESSING TEMPORAL DATA WITH LINEAR ARTIFICIAL NEURAL NETWORK LAYERS

(71) Applicant: APPLIED BRAIN RESEARCH INC., Waterloo (CA)

(72) Inventor: Andreas STOCKEL, Waterloo (CA)

(21) Appl. No.: 18/841,276

(22) PCT Filed: Feb. 23, 2023
(86) PCT No.: PCT/CA2023/050227

§ 371 Date: Aug. 23, 2024

Related U.S. Application Data
(60) Provisional application No. 63/313,676, filed on Feb. 24, 2022.

(51) Int. Cl. G06N 3/044; G06F 17/16; G06N 3/049

(52) U.S. Cl. CPC G06N 3/044; G06F 17/16; G06N 3/049

(57) ABSTRACT

The present invention relates to methods and systems for improving the efficiency of artificial neural networks by configuring them to implement linear dynamical systems that compute state updates in linear time. More specifically, the present invention specifies methods and systems for setting the weights of least one linear artificial neural network layer by (a) selecting an set of basis vectors that define a desired impulse response for the layer, (b) deriving a matrix that produces this desired impulse response over a target temporal window, (c) deriving a matrix that dampens the impulse response to zero outside of the target window, and (d) combining these two matrices together through addition to obtain the layer's recurrent weights. Systems composed of at least one such linear layer are applied to a time series of input data elements to produce outputs that encode the results of pattern classification, signal processing, data representation, and data generation tasks.

### (1) FIELD OF THE INVENTION

The present invention generally relates to the field of processing temporal data with artificial neural networks, and more specifically to improving the efficiency of these networks by configuring them to implement linear dynamical systems that compute state updates in linear time.

### (2) BACKGROUND OF THE INVENTION

Modern machine learning systems are widely used to perform tasks in which time-varying sequences of input data are mapped onto one or more output predictions. Examples of such tasks include natural language processing (e.g., mapping a sequence of words in one language onto a sequence of words in another language), automatic speech recognition (e.g., mapping a sequence of audio waveform samples onto a much shorter sequence of linguistic symbols), and generic signal processing (e.g., mapping a sequence of readings from a wearable wristband onto a sequence of heartbeat event detections). A common approach to building such systems involves the use of an artificial recurrent neural network model that uses a set of recurrently connected weights to iteratively map each item in an input sequence item into a continually evolving internal state representation. Arbitrarily long input sequences can be processed in this manner, making recurrent neural networks (RNNs) a standard choice for classifying, modeling, or otherwise processing time-series data.

Due to their generality, RNN models have both been widely studied from a theoretical perspective and widely deployed in practical contexts. Two core challenges for RNNs have emerged from these theoretical and practical investigations. First, most RNNs see their performance degrade substantially when they are tasked with processing long input sequences. Second, most RNNs also see their performance degrade substantially when their weights are quantized to lower a degree of numerical precision on specialized computing devices that are designed to be highly energy efficient (e.g., computing devices that use 8-bit integer representations rather than 32-bit floating point representations). The reason for these degradations lies in the fact that an RNN's state updates implement a kind of dynamical system, and the behavior of such systems can alter chaotically over long time spans (i.e., when the system is being driven by a long sequence of inputs), and with small state perturbations (i.e., when the system's parameters are quantized). To address these challenges and improve the stability of machine learning models designed to process time-series data, a number of innovative neural network systems have been defined in prior art. As such, the following documents and patents are provided for their supportive teachings and are all incorporated by reference: https://doi.org/10.1162/neco.1997.9.8.1735 discusses a method for adding gating mechanisms to an RNN model that allow for more stable and controlled updates the model's internal state representation, allowing for sequences of up to approximately one thousand input items to be processed reliably. Importantly, gated RNNs of this sort are often slow to train and execute on computing hardware given that they are sequentially bottlenecked and each sequential update requires O(n²) computations, where n is the dimensionality of the input items.

A further prior art document, https://arxiv.org/pdf/1706.03762.pdf, describes methods for training neural networks to process sequential data at scale by using purely feedforward “transformer” network architectures that make use of an attention mechanism to model relationships between different sequence elements. Transformers are implemented via large numbers of dense matrix multiplications that are almost perfectly suited to GPU-based parallelization, and it is accordingly possible to train them on massive amounts of data. This scalability, in tandem with the effectiveness of attention mechanisms for learning long-range data dependencies, has led transformer-based architectures to become the state-of-the-art for many time series modeling tasks, especially in the domain of natural language processing. However, transformers are not naturally suited to operating on streaming inputs. Additionally, these networks are computationally very inefficient, often requiring vast numbers of parameters to achieve good task performance. Relatedly, they operate with a quadratic O(N²) rather than linear running time with respect to input sequence length.

On the topic of efficient RNN algorithms, prior art document http://compneuro.uwaterloo.ca/files/publications/voelker.2019.lmu.pdf, describes a recurrent neural network architecture that couples one or more layers implementing a linear time-invariant (LTI) dynamical system with one or more non-linear layers to process sequential input data. The weights governing this LTI system are analytically derived to compute an optimal delay of an input signal over some temporal window, and the non-linear components of the network read from the state of this system to compute arbitrary functions of the data in the input window. The resulting network is called a “Legendre memory unit” (LMU) due to how the LTI system represents data using a Legendre basis, and experimental evidence indicates that the LMU can efficiently handle temporal dependencies spanning hundreds of thousands of time-steps, greatly surpassing the capabilities of alternative recurrent network architectures. Overall, the LMU is an important example of a linear recurrent network with strong performance characteristics, but it is nonetheless limited by the fact that it implements only one specific LTI system, namely the system that implements, for a given number of state variables, a mathematically optimal reconstruction of an input signal delayed by some number of time steps.

The methods and systems described in the aforementioned references and many similar references do not specify how to design recurrently connected artificial neural networks that implement a wide variety of linear dynamical systems that compute state updates in linear time. More specifically, the existing state-of-the-art provides no means by which to configure a linear recurrent neural network layer to efficiently implement streaming spectral decompositions of an input signal over a fixed window of input time steps, where such decompositions are encoded by the states of certain linear dynamical systems being driven by a given input signal.

The present application addresses the above-mentioned concerns and shortcomings by defining methods and systems for improving the efficiency of recurrent neural networks by configuring them to implement linear dynamical systems that compute state updates in linear time. These efficiency improvements result from defining the weights of a linear recurrent neural network layer by first selecting an set of basis functions that define the desired impulse response associated with a particular spectral decomposition, and then deriving a matrix of recurrent weights A that produce this impulse response over a temporal window of a specified length. A second matrix of recurrent weights Γ is also derived to dampen this impulse response to zero outside of the temporal window, and the recurrent weight matrix on the network layer is set to be equal to the sum of A and Γ. Specifically, this Γ matrix can be derived for arbitrary A matrices generating a basis as an impulse response, and it is furthermore guaranteed that the product between Γ and the state vector can be computed in O(n). This general method for deriving Γ provides more freedom compared to prior work in choosing a set of basis functions generated by the A matrix. Correspondingly, A can be designed to also be computed in O(n) and to be more robust to quantization (in state) and discretization (in time).

### (3) SUMMARY OF THE INVENTION PROCESSING TEMPORAL DATA WITH LINEAR ARTIFICIAL NEURAL NETWORK LAYERS

In the view of the foregoing limitations inherent in the known methods for processing temporal data with artificial neural network layers, the present invention provides methods and systems for improving the efficiency of neural networks by configuring them to implement linear dynamical systems that compute state updates in linear time. These efficiency improvements are achieved by specifying a recurrent weight matrix for the network layer that is optimized to compute impulse responses that decay to zero outside of a specified temporal window. Importantly, when the resulting linear recurrent neural network layer is applied to a time series of input data elements, each update to the layer's underlying state representations can be computed in linear time with respect to the dimensionality of these input data element (a conventional recurrent neural network layer, by comparison, computes such updates in quadratic time). The resulting state representations of the linear recurrent layer are then provided as input to at least one nonlinear neural network layer, which computes a network output that provides a solution to some computational task of interest involving the original input sequence. As such, the general purpose of the present invention, which will be described subsequently in greater detail, is to provide methods and systems for improving the efficiency of neural networks by configuring them to implement linear dynamical systems that compute state updates in linear time. In applications where recurrent layers are undesired, the method described here can be used to derive the weights of a linear temporal convolution layer that has the same behavior as the recurrent network.

The main aspect of the present invention is to define methods and systems for efficiently processing time series data with an artificial neural network model. The methods consist of defining at least one linear recurrent or temporal convolution layer, and at least one other layer that implements any nonlinear layer type, such as a perceptron layer, a self-attention layer, a convolutional layer, or a gated recurrent layer. The methods further consist of defining the recurrent or convolution weights of the at least one linear layer by (a) selecting an set of basis vectors that define a desired impulse response of this layer, (b) deriving a matrix that produces this desired impulse response over a target temporal window of length θ, (c) deriving a matrix that dampens the impulse response to zero outside of the target temporal window, and (d) combining these two matrices together through addition to obtain the layer's recurrent weights, or alternatively, using the impulse response of the LTI system obtained by summing the two feedback matrices as the convolution kernel for the linear temporal convolution layer. The methods additionally comprise applying the resulting linear recurrent layer to at least one time series of input data elements to compute at least one state vector, and then applying a non-linear layer to this state vector to produce at least one output data element that corresponds to the result of performing at least one pattern classification, signal processing, data representation, or data generation task involving the aforementioned time series of input data elements.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### (4) BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an illustration of different orthonormal basis functions generated as the impulse response of a neural network configured with the methods disclosed herein.

FIG. 2 is an illustration of the accuracy of generated impulse responses (relative to target impulse responses) produced by a neural network configured with the methods disclosed herein.

FIG. 3. is an illustration of the accuracy of window-truncated impulse responses (relative to target impulse responses) produced by a neural network configured with the methods disclosed herein.

FIG. 4. is an illustration of the accuracy of signal delays computed by different recurrent neural network layers configured using the methods disclosed herein.

FIG. 5. is an illustration of the accuracy of signal delays on a per time-step basis over a delay window computed by different recurrent neural network layers configured using the methods disclosed herein.

### (5) DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention is described in brief with reference to the accompanying drawings. Now, refer in more detail to the exemplary drawings for the purposes of illustrating non-limiting embodiments of the present invention.

As used herein, the term “comprising” and its derivatives including “comprises” and “comprise” include each of the stated integers or elements but does not exclude the inclusion of one or more further integers or elements.

As used herein, the singular forms “a”, “an”, and “the” include plural referents unless the context clearly dictates otherwise. For example, reference to “a device” encompasses a single device as well as two or more devices, and the like.

As used herein, the terms “for example”, “like”, “such as”, or “including” are meant to introduce examples that further clarify more general subject matter. Unless otherwise specified, these examples are provided only as an aid for understanding the applications illustrated in the present disclosure, and are not meant to be limiting in any fashion.

As used herein, the terms “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein.

Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

For simplicity and clarity of illustration, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

The embodiments of the artificial neural networks described herein may be implemented in configurable hardware (i.e., an FPGA) or custom hardware (i.e., an ASIC), or a combination of both with at least one interface. The input signal is consumed by the digital circuits to perform the functions described herein and to generate the output signal. The output signal is provided to one or more adjacent or surrounding systems or devices in a known fashion.

As used herein the term ‘node’ in the context of an artificial neural network refers to a basic processing element that implements the functionality of a simulated ‘neuron’, which may be a spiking neuron, a continuous rate neuron, or an arbitrary linear or non-linear component used to make up a distributed system.

The described systems can be implemented using adaptive or non-adaptive components. The system can be efficiently implemented on a wide variety of distributed systems that include a large number of non-linear components whose individual outputs can be combined together to implement certain aspects of the system as will be described more fully herein below.

The main embodiment of the present invention is a set of systems and methods for efficiently processing time series data with an artificial neural network model. The methods consist of defining at least one linear recurrent or linear temporal convolution layer, and at least one other layer that implements any nonlinear layer type, such as a perceptron layer, a self-attention layer, a convolutional layer, or a gated recurrent layer. The weights of the at least one linear layer are configured by first selecting an set of basis vectors that define a desired impulse response, and then deriving a matrix that produces this desired impulse response over a target temporal window of length θ. Next, a second matrix is derived that dampens this desired impulse response to zero everywhere outside of the target temporal window of length θ, and the linear layer's connection weights are set to be equal to the sum of these two matrices in the case of a linear recurrent layer, or the impulse response of the corresponding LTI system in the case of a linear temporal convolution layer. Methods for operating the resulting linear neural network layer consist of applying it to at least one time series of input data elements to compute at least one state vector that is updated iteratively as each item in the input sequence is provided to the layer. These methods further comprise applying that at least one non-linear layer to this state vector to produce at least one output data element that solves at least one pattern classification, signal processing, data representation, or data generation task involving the time series of input data elements.

The term ‘artificial recurrent neural network model’ here refers to an artificial neural network model that contains at least one set of weighted connections that transfer the output of one or more nodes in a given network layer back as input to one or more nodes in the same layer. These weighted connections are referred to as ‘recurrent connections’, and they typically introduce complex state dynamics into an artificial neural network model, since the model's node outputs can evolve drastically over time as a consequence of the feedback loops introduced by said recurrent connections. Standard implementations of artificial recurrent neural network models perform O(n) computations with respect to the length of the input sequence they are applied to, and O(n²) computations with respect to the dimensionality of each item in this input sequence.

The term ‘activation function’ here refers to any method or algorithm for applying a linear or nonlinear transformation to some input value to produce an output value in an artificial neural network. Examples of activation functions include the identity, rectified linear, leaky rectified linear, thresholded rectified linear, parametric rectified linear, sigmoid, tanh, softmax, log softmax, max pool, polynomial, sine, gamma, soft sign, heaviside, swish, exponential linear, scaled exponential linear, and gaussian error linear functions. The term ‘linear network layer’ here refers to any layer in an artificial neural network that computes its output values using a linear activation function such as the identity function.

Activation functions may optionally output ‘spikes’ (i.e., one-bit events), ‘multi-valued spikes’ (i.e., multi-bit events with fixed or floating bit-widths), continuous quantities (i.e., floating-point values with some level of precision determined by the given computing system—typically 16, 32, or 64-bits), or complex values (i.e., a pair of floating point numbers representing rectangular or polar coordinates). These aforementioned functions are commonly referred to, by those of ordinary skill in the art, as ‘spiking’, ‘multi-bit spiking’, ‘non-spiking’, and ‘complex-valued’ neurons, respectively. When using spiking neurons, real and complex values may also be represented by one of any number of encoding and decoding schemes involving the relative timing of spikes, the frequency of spiking, and the phase of spiking. However, it will be understood by those of ordinary skill in the art that the embodiments described herein may be practiced without these specific details.

The term ‘dynamical system’ here refers to any system in which the system state can be characterized using a collection of numbers corresponding to a point in a geometrical space, and in which a function is defined that relates this system state to its own derivative with respect to time. In other words, a dynamical system comprises a state space along with a function that defines transitions between states over time. The term ‘linear time-invariant dynamical system’ refers to a specific class of dynamical system for which the relationship between the system's input at a given time and its output is a linear mapping; moreover, this mapping is time invariant in the sense that a given input will be mapped to the same output regardless of the time at which the input is applied. LTI systems have the advantage of being relatively easy to analyze mathematically in comparison to more complex, nonlinear systems. In the context of the present invention, a particularly important form of mathematical analysis specifies how to write the state update equation for an LTI system in a non-sequential form. All linear recurrent neural network layers implement LTI systems, with the configuration of the layer's connection weights determining which specific LTI system it implements. Accordingly, all linear recurrent neural network layers also implement dynamical systems.

The term ‘impulse response’ here refers to a mathematical description of an LTI system's output in response to an instantaneous input of unit magnitude. A dynamical system's impulse response more generally defines how it behaves as a function of time under specific input conditions. For any LTI system, the system's behavior is completely characterizable in terms of its impulse response, since an instantaneous pulse of unit magnitude comprises a combination of all possible input frequencies, and thereby stimulates the response of the system to all possible input frequencies. Due to the constraints of linearity and time invariance, the response thereby defines the behavior of the system exhaustively for all possible inputs over time. Mathematically, LTI systems are characterized in terms of an input u(t) that gets mapped through an matrix B to produce a state representation m(t), which in turn gets mapped through a recurrent matrix A, such that the instantaneous change to m is described by the following relationship:

$$\dot{m} ( t ) = Am ( t ) + Bu ( t ) \qquad ( 1 )$$

The term ‘basis vector’ here refers to a vector that belongs to a set of vectors that spans a given vector space. The term ‘set of basis vectors’ here refers to a collection of basis vectors for which none of the individual vectors in this collection can be expressed as a linear combination of any of the other vectors in the collection. The term ‘basis function’ here refers to a function that belongs to a set of functions that similarly spans a given function space. The term ‘spectral decomposition’ here refers to the process of taking a sliding window over a time-varying one-dimensional signal, and decomposing the signal within this window into a weighted combination of some chosen set of basis functions or basis vectors. Often, these basis functions or basis vectors correspond to different signal frequency components present within the sliding window, in which case the basis is the Fourier basis. Other common choices for a basis include cosine functions over a range of frequencies (i.e., a “cosine basis”) and a set of orthogonal Legendre polynomials (i.e., “Legendre basis”). Other polynomials that can be used as bases include the Legendre, Chebyshev, Laguerre, Hermite, and Jacobi polynomials.

The nonlinear components of the aforementioned systems can be implemented using a combination of adaptive and non-adaptive components. Examples of nonlinear components that can be used in various embodiments described herein include simulated/artificial neurons, FPGAs, GPUs, and other parallel computing systems. Components of the system may be implemented using a variety of standard techniques such as by using microcontrollers. In addition, non-linear components may be implemented in various forms including software simulations, hardware, or any neuronal fabric. Non-linear components may also be implemented using neuromorphic computing devices such as Neurogrid, SpiNNaker, Loihi, and TrueNorth.

As an illustrative embodiment of the proposed systems and methods, consider the challenge of constructing LTI systems that approximate sliding-window spectra for arbitrary bases. In canonical form, an LTI system of this sort can be described in terms of input to the system, u, that is mapped through a matrix B, while the system state is mapped through a recurrent matrix A at each timestep. To realize an LTI system that has q orthonormal basis functions bi as an impulse response over a target window [0, θ], then the state m(t) of that system can be described in terms of the following integral:

$${m}_{i} ( t ) = {\int }_{0}^{θ} u ( t - τ ) ) {b}_{i} ( t ) d τ \qquad ( 2 )$$

where τ is the integration variable ranging over all possible shifts with respect to t. Another way to interpret m(t) is as a compressed representation of u [t−θ,t]. That is, realizing q temporal basis functions as an LTI system continuously compresses u [t−θ, t] into a q-dimensional vector m(t). For q→∞, m(t) represents all information in the windowed input signal u [t−θ, t]. Correspondingly, it is possible to compute any nonlinear function over u [t−θ, t] by transforming m(t) nonlinearly. One could, for example, represent m in a neural network and decode a function ƒ(m).

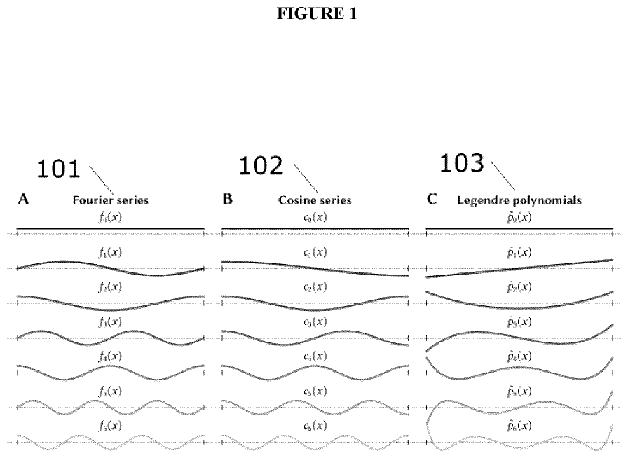

Referring to FIG. 1, if q is set to six and the Fourier series is used as a basis, then m(t) is a linear combination of sine and cosine functions [101] that reconstructs a signal u over the window of length θ. Alternatively, if a Cosine series [102] or the Legendre polynomials [103] are used as a basis, then m(t) is again a linear combination of basis functions that optimally reconstructs a signal u over a window of length θ, but different basis are used in each case. Importantly, it is possible to derive the A and B matrices of LTI systems that generate the above bases using only q state dimensions over N timesteps. Consider an orthonormal basis transformation matrix M∈R^{q×N}. The ith column (with i∈{1, . . . , N}) of M, here denoted as mᵢ, is a q-dimensional vector describing the impulse response of the desired system at t=Δti, where Δt=θ/N. If the state evolution is indeed the result of a time-invariant linear process, then we have

$${m}_{0} = \underline{B} , {m}_{i + 1} = {m}_{i} + Δ t \underline{A} {m}_{i} ⇔ \underline{A} {m}_{i} = \frac{{m}_{i + 1} - {m}_{i}}{Δ t}$$

for all 1≤i<N, where B describes the influence of the initial impulse on the state, and A is the state-transition matrix. Finding a matrix A with this property can be written as a linear least-squares problem:

$$\underline{A} = arg {min}_{\underline{A}} {\sum }_{i = 1}^{N - 1} {‖ \underline{A} {m}_{i} - \frac{{m}_{i + 1} - {m}_{i}}{Δ t} ‖}_{2}^{2} \qquad ( 2 )$$

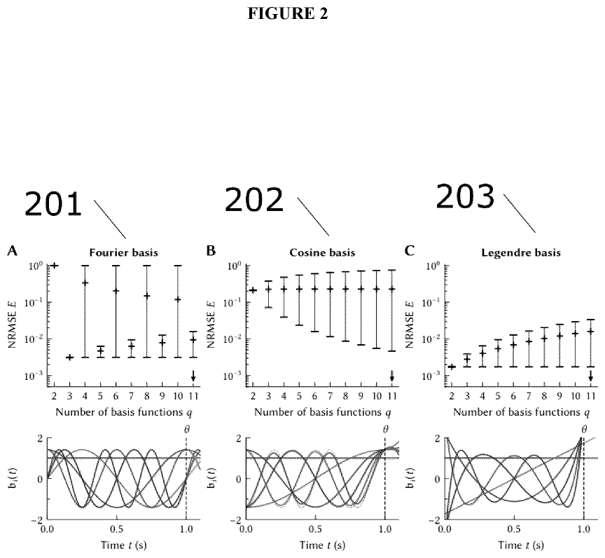

This is a standard autoregressive linear model, and it is possible to use the derivative of a continuous basis instead of the difference quotient, produce A and B as the result of discretizing the LTI system with a zero-order hold assumption as follows:

$$A = \frac{1}{Δ t} log ( I + Δ t \underline{A} ) , B = √ NB ,$$

where ‘log’ is the matrix logarithm, the inverse operation of taking the matrix exponential. Referring to FIG. 2, this approach to deriving A and B produces the desired LTI system impulse response for each of the Fourier [201], Cosine [202], and Legendre [202] bases, with varying degrees of error.

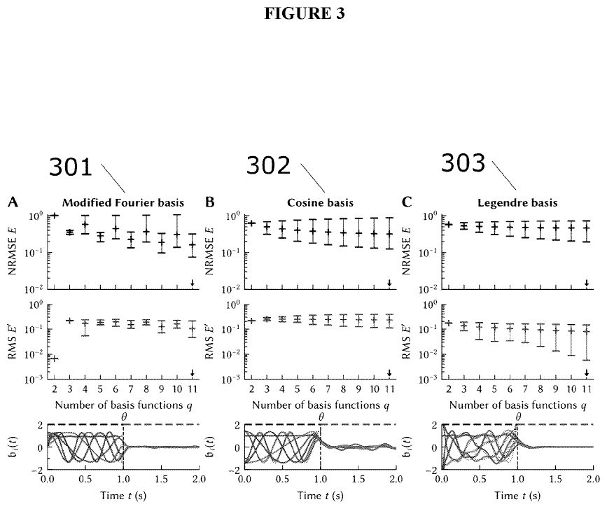

The impulse responses produced from this derivation of A and B are not limited to the target window of length θ, however. To limit the responses to this window, it is possible to decode a delayed version of the input signal u(t−θ) from the system state m(t). It is furthermore possible to compute the specific contribution m(t) of u(t−θ) to m(t). Subtracting m(t) from m(t) effectively ‘erases’ any information about u(t−θ) from the state vector, resulting in a rapidly decaying and almost finite impulse response. The resulting ‘information erasure’ update is linear and can be expressed as a rank-one matrix Γ. Referring to FIG. 3, the effects are shown of this ‘information erasure’ procedure on the LTI systems generating modified Fourier [301], Cosine [302] and Legendre [303] bases. To generate the modified Fourier basis, the oscillations of the Fourier basis are slowed by 10%, making the basis aperiodic and compatible with information erasure. This new modified Fourier basis is no longer orthonormal, and thus is information theoretically suboptimal. For both the modified Fourier and Legendre basis, the method indeed approximates a rectangle window, yet introduces ringing artifacts. The method stabilizes the cosine basis, but there are still residual oscillations for t>θ—this is likely because the cosine basis is not realized well by the underlying LTI system.

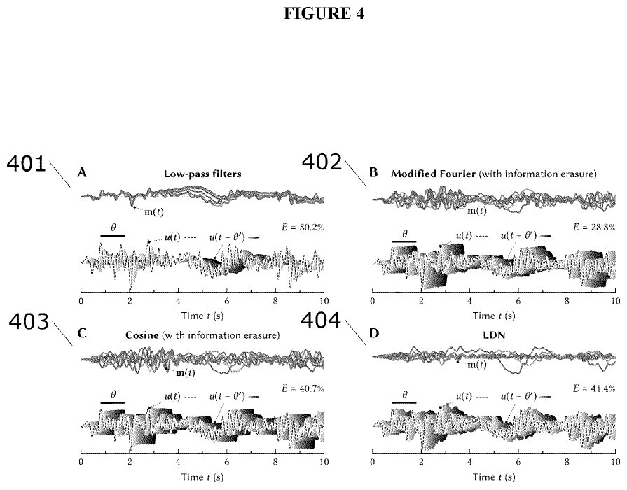

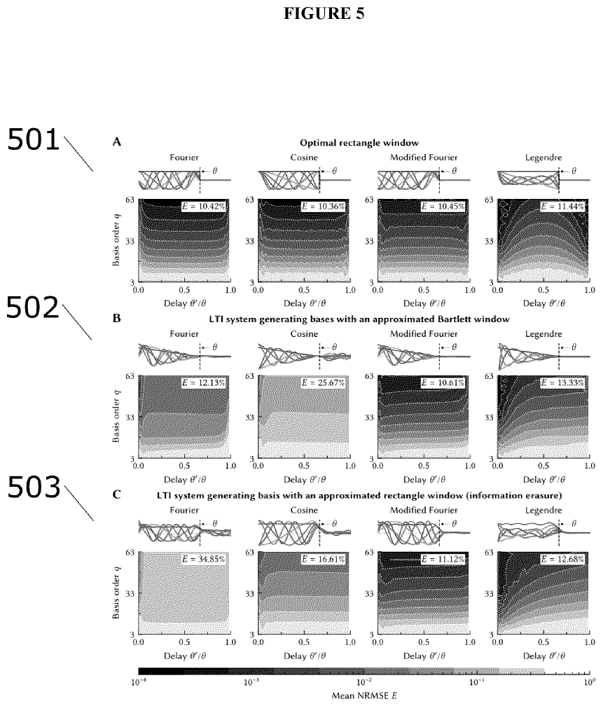

In theory, the different function bases just discussed possess the same representational power. In continuous form, they span the function space L²(0, θ), and in the discrete case they span the N-dimensional vector space R^{N}. However, differences arise with respect to the accuracy with which it is possible to decode functions if the bases are truncated to include only q terms, especially when generating the bases as the impulse response of an LTI system of order q. One way to quantitatively characterize these differences involves measures how accurately one can decode delayed versions of the input signal u(t) from the system state m(t). As such, results from a number of benchmarking experiments are described below to provide a demonstration of the methods and systems disclosed herein for processing temporal data with recurrently connected artificial neural networks. Referring to FIG. 4, a one second delay is computed from m(t) using a dynamical system that computes a low pass filter on an input signal [401], along with systems that compute impulse responses corresponding to a modified Fourier basis [402], a Cosine basis [403], and Legendre basis [404]. The modified Fourier basis provides the lowest overall level of decoding error, improving on the Cosine and Legendre bases by more than 25% in relative terms. Referring to FIG. 5, it is also possible to compare the accuracy of computing a one second delay on a per-time-step basis with Fourier, Cosine, modified Fourier, and Legendre bases, under varying values of q and with differing approaches to truncating a system's impulse response to a target window length. Using a ideal truncated impulse response [501] understandably produces the lowest level of overall error for all bases, while using an approximated Bartlett window to the truncate the response [502] produces low error with modified Fourier basis, but higher levels of error for the other bases. Using the method of information erasure [503], finally, results in the modified Fourier basis producing the lowest overall level of error. Notably, the Legendre basis provides only a slightly higher level of error, but is nonetheless much more accurate at reconstructing inputs from early in the delay period in comparison to inputs from later in the delay period; the modified Fourier basis, by comparison, is more uniformly accurate across all points in the delay period. Overall, these analyses clearly demonstrate the advantages of the proposed methods and systems for processing time-series data efficiently.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

1. A computer implemented method for efficiently processing time series data with an artificial neural network model, comprising:
a. defining at least one linear layer with input of one or more dimensions; this linear layer can either be implemented as a recurrent linear layer, or as a linear temporal convolution layer;
b. defining at least one other layer that implements any nonlinear layer type, such as a perceptron layer, a self-attention layer, a temporal convolutional layer, or a gated recurrent layer;
c. defining the recurrent and input weights of the at least one linear recurrent layer, or the weights of the linear temporal convolution layer by:
i. selecting set of basis vectors that define the desired impulse response of the at least one linear recurrent layer over a temporal window of length θ.
ii. deriving a matrix of recurrent weights A that produce this desired impulse response over the temporal window of length θ, such that multiplication of at least one vector by this matrix A can be computed in O(n) time, where n is the dimensionality of the at least one vector;
iii. deriving a matrix of recurrent weights Γ that dampens this impulse response to zero outside of the temporal window of length θ, such that multiplication of at least one vector by this matrix Γ can be computed in O(n) time, where n is the dimensionality of the at least one vector;
iv. either setting the recurrent weights of the at least one linear recurrent layer to be the sum of the weights A and the weights Γ or setting the weights of the linear temporal convolution layer to the impulse response of the LTI system defined by the sum of the weights A and the weights Γ;
d. applying the at least one linear layer to at least one time series of input data elements to compute at least one state vector that represents the at least one time-series of input data elements as a linear combination of the aforementioned basis vectors.
e. applying the at least one non-linear layer to the at least one state vector to produce at least one output data element, thereby performing at least one pattern classification, signal processing, data representation, or data generation task involving the at least one time series of input data elements.

2. The method of claim 1, wherein the basis functions are a modified Fourier, Cosine, Haar, Legendre, Chebyshev, Laguerre, Hermite, or Jacobi basis.

3. The method of claim 1, wherein one or more layers is implemented as a spiking neural network.

4. The method of claim 1, wherein the length of the window can be adapted during the execution of the network.

5. The method of claim 1, wherein the window allows an arbitrary weighting.

6. A system for efficiently processing time series data with an artificial neural network model, the system comprising:
a. at least one linear layer with weight matrices configured in accordance with claim 1; and
b. at least one other layer that implements any nonlinear layer type, such as a perceptron layer, a self-attention layer, a temporal convolutional layer, or a gated recurrent layer;
wherein the system is operated to perform at least one pattern classification, signal processing, data representation, or data generation task by first passing at least one time series of input data elements through the at least one linear layer to compute at least one state vector, and then passing this at least one state vector through the at least one non-linear layer to produce at least one output data element, thereby performing at least one pattern classification, signal processing, data representation, or data generation task involving the at least one time series of input data elements.

7. The system of claim 6 wherein one or more layers are implemented as spiking neural networks.

8. The system of claim 6, wherein the length of the window can be adapted during the execution of the network.

9. The system of claim 6, wherein the window allows an arbitrary weighting.
